(19) United States
(12) Patent Application Publication
(10) Pub. No.: US 2016/0077859 A1
(43) Pub. Date: Mar. 17, 2016

(54) EXPEDITING HOST MAINTENANCE MODE IN CLOUD COMPUTING ENVIRONMENTS

(71) Applicant: International Business Machines Corporation, Armonk, NY (US)

(72) Inventor: Joseph W. Cropper, Rochester, MN (US)

(21) Appl. No.: 14/488,164

(22) Filed: Sep. 16, 2014

Related U.S. Application Data
(63) Continuation of application No. 14/484,871, filed on Sep. 12, 2014.

(51) Int. Cl. G06F 9/455

(52) U.S. Cl. CPC G06F 9/45558; G06F 2009/45575; G06F 2009/45591

(57) ABSTRACT

A maintenance mode mechanism (MMM) expedites host maintenance in a cloud computing environment by intelligently suspending essentially inactive virtual machines. The user is given the option to enter maintenance mode using the MMM. The MMM determines essentially inactive VMs that can be suspended to reduce the number of VMs that need to be migrated prior to entering a maintenance mode. Metrics of the VMs associated with the host are analyzed to determine which VMs can be suspended. Parameters can also be set by the user to instruct the MMM to verify the selection of a specific VM with the user.

### BACKGROUND

1. Technical Field

This invention generally relates to cloud computer systems, and more specifically relates to expediting host maintenance in a cloud computing environment by intelligently suspending essentially inactive virtual machines based on metrics of the virtual machines.

2. Background Art

Cloud computing is a common expression for distributed computing over a network and can also be used with reference to network-based services such as Infrastructure as a Service (IaaS). IaaS is a cloud based service that provides physical processing resources to run virtual machines (VM) as a guest for different customers. The virtual machine may host a user application or a server.

In cloud computing environments, a common control-level operation is “enter maintenance mode”. This operation is typically performed by a cloud controller or a hypervisor. Entering maintenance mode requires an evacuation of active virtual machines (VMs) off of the hypervisor. The operation of entering maintenance mode is typically initiated by an administrator when the server needs to be taken offline to upgrade firmware or perform activities which may be potentially disruptive to active workloads. Depending on how loaded the hypervisor is with VMs, it may take a long time to evacuate the active VMs to other hosts (i.e., due to the increased load on network and storage infrastructures). The evacuation process may take anywhere from a few minutes to a few hours. Additionally, the more VMs that need to be evacuated, the higher the risk of encountering a problem while moving a VM from one host to another.

### BRIEF SUMMARY

An apparatus and method expedites host maintenance in a cloud computing environment by intelligently suspending essentially inactive virtual machines. The user is given the option to enter maintenance mode using a maintenance mode mechanism (MMM) that determines essentially inactive VMs that can be suspended to reduce the number of VMs that need to be migrated prior to entering a maintenance mode. Metrics of the VMs associated with the host are analyzed to determine which VMs can be suspended. The MMM allows the user to set a hold active bit in a table to prevent a virtual machine from being suspended.

The foregoing and other features and advantages of the invention will be apparent from the following more particular description of preferred embodiments of the invention, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a cloud computing node;

FIG. 2 is a block diagram of a cloud computing environment;

FIG. 3 is a block diagram of abstraction model layers;

FIG. 4A is a block diagram for an example networked computer system incorporating a maintenance mode mechanism as described herein;

FIG. 4B is a block diagram for an example networked computer system incorporating a maintenance mode mechanism as described herein;

FIG. 5 is a table with metrics and thresholds used by the maintenance mode mechanism as described herein;

FIG. 6 is a table with a hold active bit for each VM in a host;

FIG. 7 is a flow diagram of a method for a maintenance mode mechanism;

FIG. 8 is a flow diagram of an example method for step 750 in FIG. 7; and

FIG. 9 is a flow diagram of another example method for step 750 in FIG. 7.

### DETAILED DESCRIPTION

The claims and disclosure herein provide mechanisms and methods for expediting host maintenance in a cloud computing environment by intelligently suspending essentially inactive virtual machines. The user is given the option to enter maintenance mode using a maintenance mode mechanism (MMM) that determines essentially inactive VMs that can be suspended to reduce the number of VMs that need to be migrated prior to entering a maintenance mode. Metrics of the VMs associated with the host are analyzed to determine which VMs can be suspended. The MMM allows the user to set a hold active bit in a table to prevent a virtual machine from being suspended.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

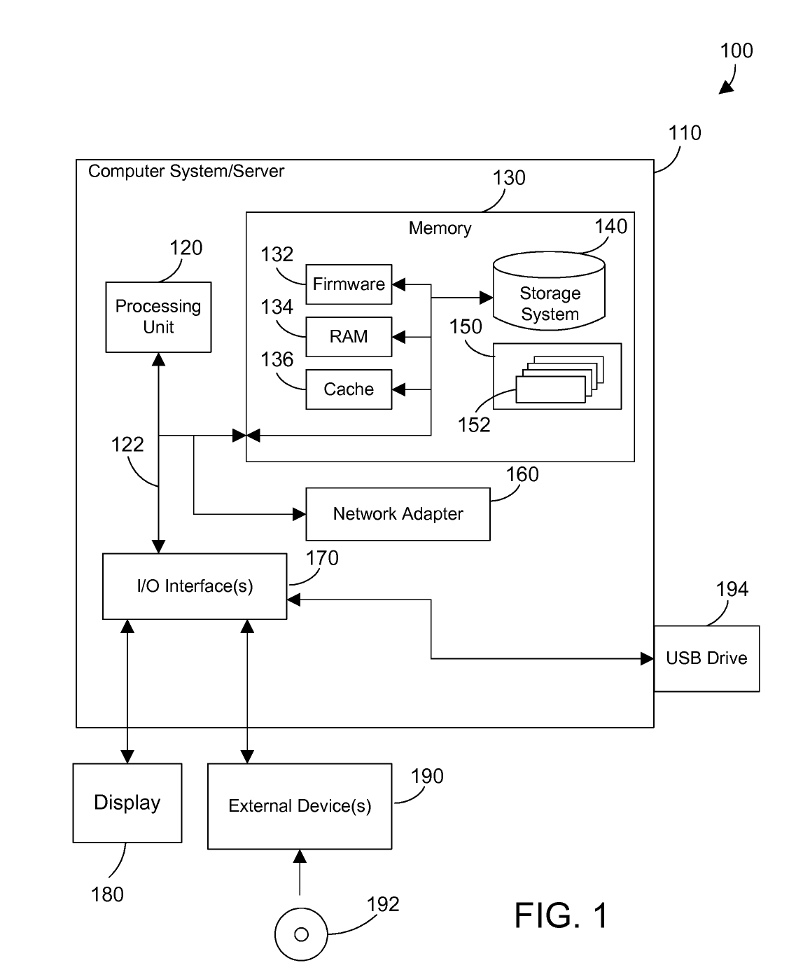

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processing unit 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media. Examples of removable media are shown in FIG. 1 to include a Digital Video Disc (DVD) 192 and a USB drive 194.

System memory 130 can include computer system readable media in the form of volatile or non-volatile memory, such as firmware 132. Firmware 132 provides an interface to the hardware of computer system/server 110. System memory 130 can also include computer system readable media in the form of volatile memory, such as random access memory (RAM) 134 and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. One suitable example of an external device 190 is a DVD drive which can read a DVD 192 as shown in FIG. 1. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, Redundant Array of Independent Disk (RAID) systems, tape drives, data archival storage systems, etc.

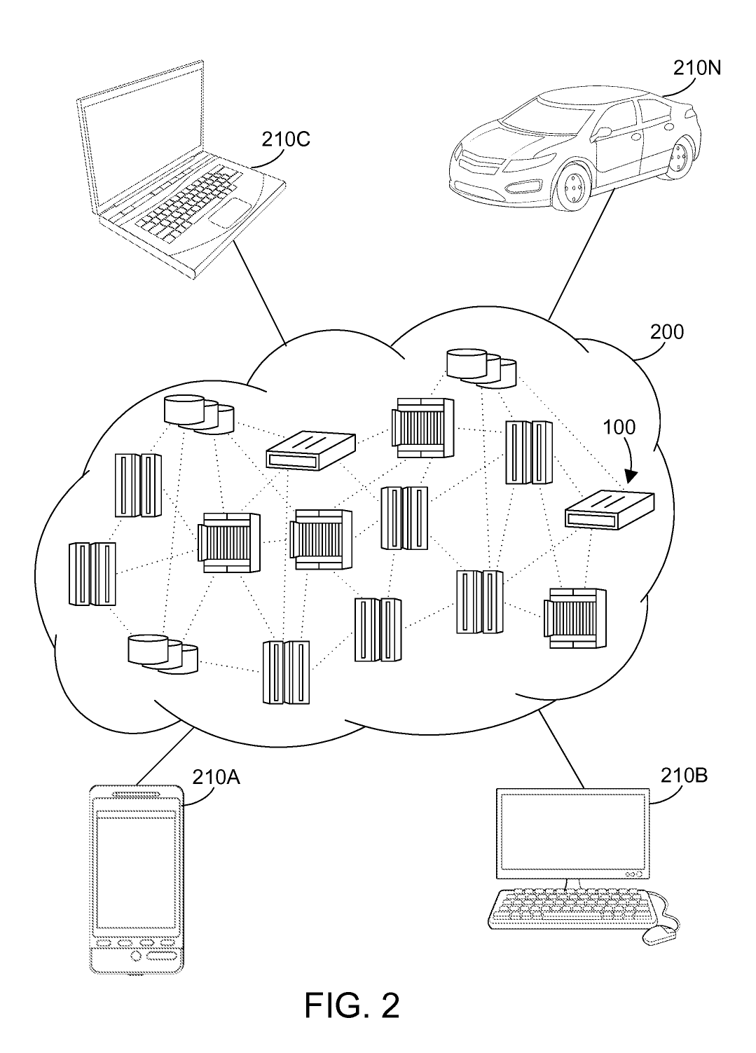

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

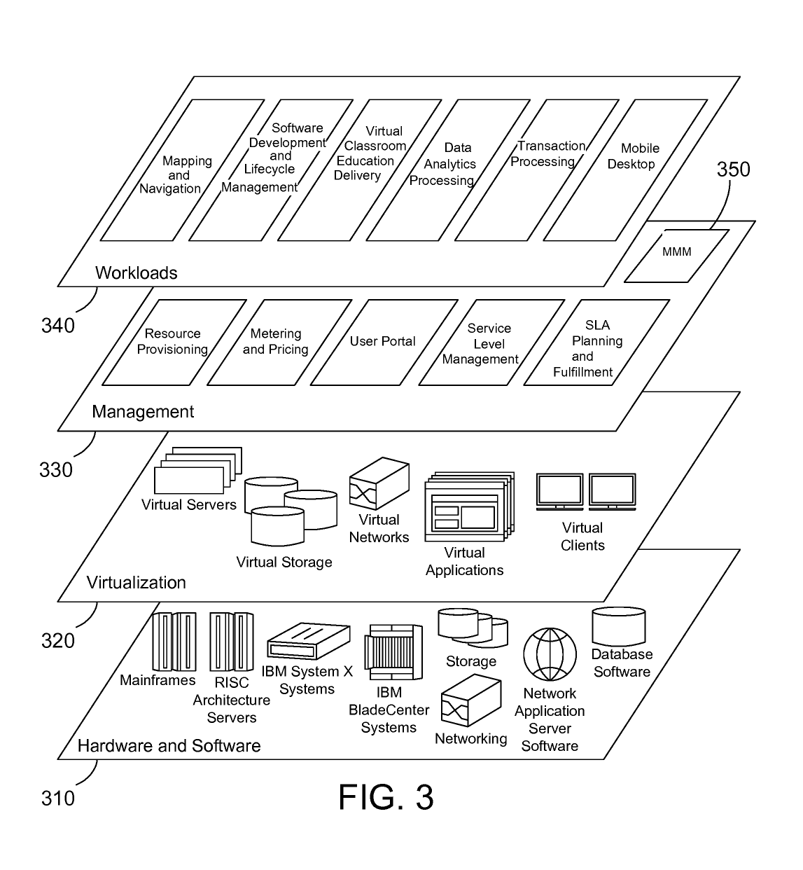

Referring now to FIG. 3, a set of functional abstraction layers provided by cloud computing environment 200 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes, in one example IBM System z systems; RISC (Reduced Instruction Set Computer) architecture based servers, in one example IBM System p systems; IBM System x systems; IBM BladeCenter systems; storage devices; networks and networking components. Examples of software components include network application server software, in one example IBM WebSphere® application server software; and database software, in one example IBM DB2® database software. IBM, System z, System p, System x, BladeCenter, WebSphere, and DB2 are trademarks of International Business Machines Corporation registered in many jurisdictions worldwide.

Virtualization layer 320 provides an abstraction layer from which the following examples of virtual entities may be provided: virtual servers; virtual storage; virtual networks, including virtual private networks; virtual applications and operating systems; and virtual clients.

In one example, management layer 330 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. The management layer further includes a maintenance mode mechanism (MMM) 350 as described herein. While the MMM 350 is shown in FIG. 3 to reside in the management layer 330, LAM 350 actually may span other levels shown in FIG. 3 as needed. The MMM may be incorporated into a cloud controller or a hypervisor known in the prior art.

Workloads layer 340 provides examples of functionality for which the cloud computing environment may be utilized. Examples of workloads and functions which may be provided from this layer include: mapping and navigation; software development and lifecycle management; virtual classroom education delivery; data analytics processing; transaction processing and mobile desktop.

As will be appreciated by one skilled in the art, aspects of this disclosure may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As introduced above, entering maintenance mode typically requires an evacuation of active virtual machines (VMs) off of the host. After the operator initiates putting the host machine in maintenance mode, the system begins moving the active virtual machines off the host. This is typically performed by a management portion of the cloud software sometimes referred to as a cloud controller. Depending on how loaded the host is with VMs, it may take a long time to evacuate the active VMs to a different host. As described further below, the maintenance mode mechanism expedites host maintenance by intelligently suspending essentially inactive virtual machines. The suspending of VMs may use heuristic methods in an effort to suspend the best candidates to expedite the maintenance mode with the least impact on system performance. Essentially inactive VMs are VMs that are active but rarely used or that are determined via the VM metrics to be sufficiently inactive that they can be suspended without serious repercussions. VMs on the host that are suspended do not need to be relocated. The state of a suspended VM is saved to disk and can be resumed after the maintenance mode is finished. The process of suspending VMs and resuming VMs are known operations in the prior art. The various functions of the MMM described herein can be incorporated into the cloud controller and/or the hypervisor which execute on a computer such as computer system 110 shown in FIG. 1.

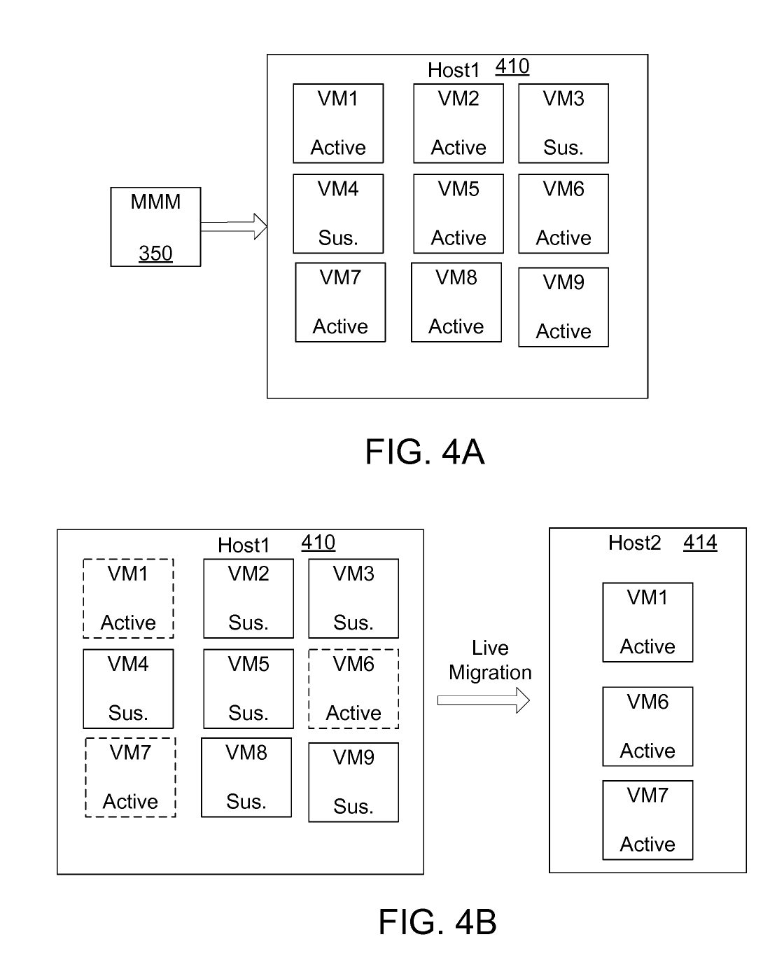

Referring now to FIG. 4A, a block diagram presents an example of a maintenance mode mechanism (MMM) 350 that intelligently places a host 410 in maintenance mode as described herein. Host1 410 represents a host server such as a virtual server shown in FIG. 3 that is operating on a physical machine. This physical machine may be one of the systems shown in the hardware and software level 310 in FIG. 3. Host1 410 may have any number of VMs allocated to it. For simplicity, in this example Host1 410 is shown having 9 VMs (VM1-VM9). The status of the VMs on Host1 410 may be active or suspended. As introduced above, active VMs must be relocated off of the host prior to entering maintenance mode in order to continue service of the VM. Any VMs that are already suspended can be left in the suspended mode on the host. In this example, VM3 and VM4 are already suspended. So the process of putting Host1 into maintenance mode would normally require relocating the remainder 7 VMs to a different host prior to placing the host in maintenance mode. It is important to note that in a real system environment the number of active VMs may be much larger than in this example and could take a long time to relocate compared to relocating the small number shown here.

Again referring to FIG. 4A, the MMM 350 expedites the process of placing Host 1 410 into maintenance by intelligently suspending essentially inactive virtual machines. The user may be given the option to begin the process when the maintenance mode is initiated. Alternatively, the process of intelligently suspending essentially inactive virtual machines may begin automatically upon starting the maintenance mode. The MMM then determines essentially inactive VMs that can be suspended to reduce the number of VMs that need to be migrated prior to entering a maintenance mode. A VM is determined to be essentially inactive based on one or more metrics of the VM and thresholds set for the metrics by an administrator or user. For this example, it is assumed that the MMM determines that VM2, VM5, VM8 and VM9 are essentially inactive and can be suspended.

Referring now to FIG. 4B, a block diagram continues the example of a maintenance mode mechanism (MMM) 410 that intelligently places a host 410 in maintenance mode as discussed with reference to FIG. 4A. FIG. 4B shows that the VMs that were determined to be essentially inactive have now been suspended. Specifically, VM2, VM5, VM8 and VM9 have been suspended along with VM3 and VM4 which were already suspended. After suspending the essentially inactive VMs, there are some remaining VMs that do not meet the parameters of an essentially inactive VM. These VMs are thus determined to be active and must be reallocated to another host. The system can then proceed to place Host1 410 in maintenance mode in the manner known in the prior art by reallocating the active VMs and placing the host in maintenance mode. As shown in the example of FIG. 4B, the active VMs (VM1, VM6 and VM7) are relocated by live migration to Host2 414 in the manner known in the prior art.

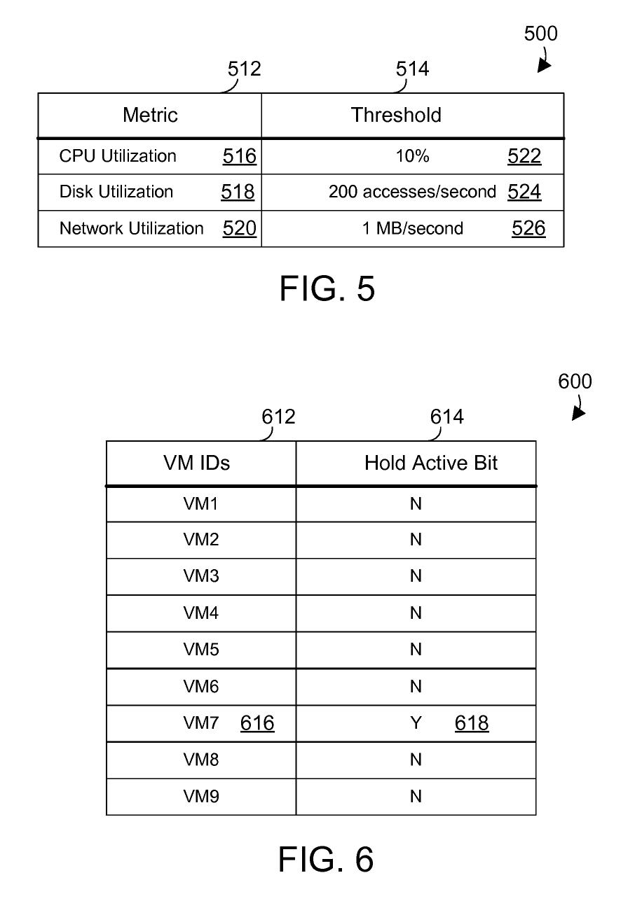

FIG. 5 illustrates a table which includes example metrics 512 and thresholds 514 that can be used by the maintenance mode mechanism to intelligently suspend essentially inactive virtual machines. It is not necessary that the VM be completely inactive. The MMM analyzes each of the VMs to determine if the VM is essentially inactive based on metrics and thresholds. The MMM determines that a VM is inactive using at least one metric or a combination of metrics. The example metrics 512 include CPU utilization 516, disk utilization 518 and network utilization 520. A threshold 514 can be any parameter related to the metric. In the illustrated examples, a threshold for CPU utilization metric 516 includes a percentage of maximum utilization of 10 percent 522. A threshold for disk utilization 518 includes 200 accesses per second 524. A threshold for network utilization 520 includes 1 megabyte of data per second 526. Other metrics related to a VM could also be used to determine the VM is essentially inactive. In addition, the thresholds could include a historical perspective of the metric. For example, the CPU utilization metric may include a threshold such as “10% within the last hour”. Thus the threshold for each metric may use any suitable time frame such as minute, hour, day, week, etc. Further, the metrics shown in FIG. 5 can be used in combination to determine when a VM is essentially inactive. For example, it may be advantageous to insure all the metrics, or a subset of the metrics, are satisfied before deciding a VM is essentially inactive.

FIG. 6 illustrates a table 600 for storing VM identifications (VM IDs) 612 and corresponding hold active bits 614. As described above, the MMM determines from the metrics whether a VM is essentially inactive in order to suspend the VM. There is a risk that some VMs may be inappropriately suspended. A VM may appear to be inactive according to the metrics and thresholds even though it is executing critical functions. The table 600 holds a bit for each VM in the host to indicate to the system that the VM is not to be suspended regardless of any metrics. In the illustrated example shown in FIG. 6, VM7 616 has a positive or “yes” bit 618 that indicates VM7 should not be suspended. Thus, in the example shown in FIG. 4, VM7 would be left active based on its hold active bit in FIG. 6 so VM7 is relocated to the new host regardless of any metrics that may indicate VM7 is essentially inactive. The “yes” 618 bit shown in FIG. 6 may actually be stored as a binary “1” bit, an alphanumeric character “y” or any other suitable indicator. In another example, instead of a table storing the hold active bit, each VM may have a hold active bit stored as part of the VM. The administrator may be given the option to edit or set the hold inactive bit. Alternatively, the MMM could verify the selection of each specific VM or type of VM with the user.

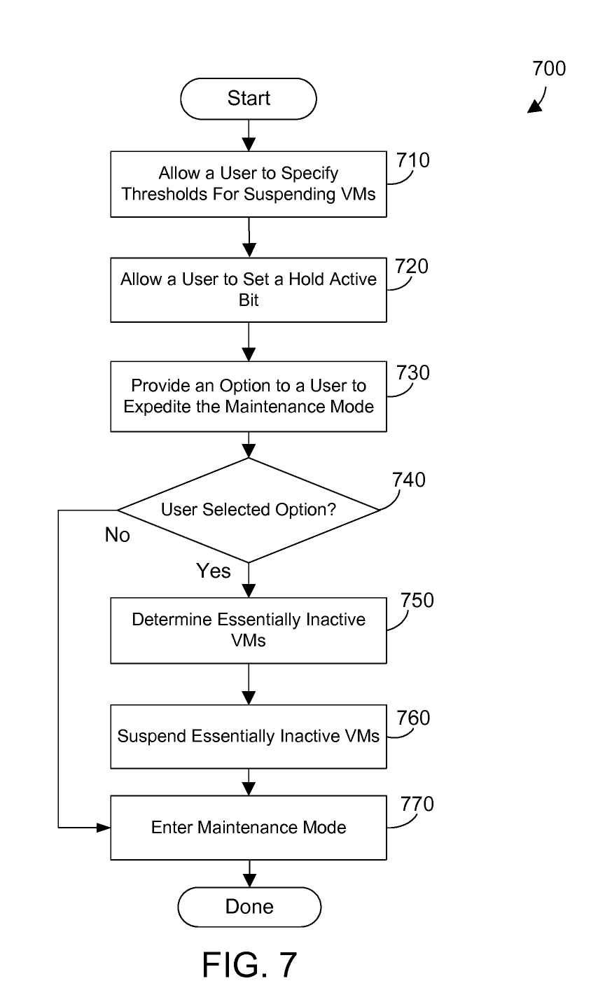

FIG. 7 illustrates a flow diagram of a method 700 for expediting host maintenance in a cloud computing environment by intelligently suspending essentially inactive virtual machines. The method 700 is presented as a series of steps performed by a computer software program such as the maintenance mode mechanism 350 described above. Allow a user to specify thresholds for suspending virtual machines (step 710). Allow the user to set a hold active bit (step 720). Provide the user an option to expedite the maintenance mode (step 730). If the user does not select the option to expedite the maintenance mode (step 740=no) then go to step 760 and enter maintenance mode. If the user selects the option to expedite the maintenance mode (step 740=yes) then determine essentially inactive VMs (step 740). Suspend the determined VMs in the previous step (step 750). Enter maintenance mode (step 760). The method is then done.

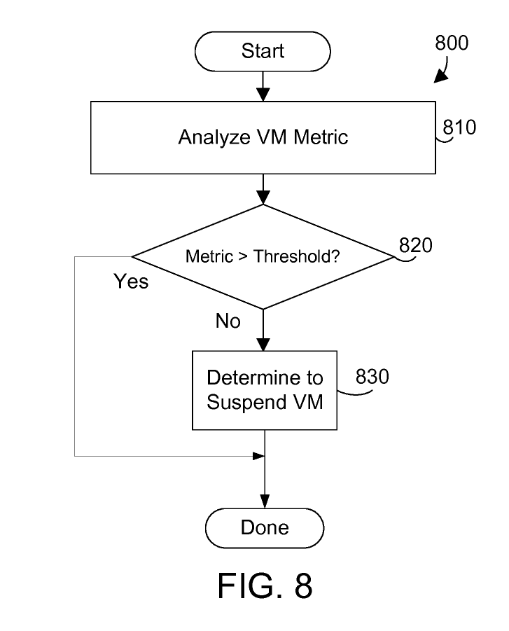

Referring now to FIG. 8, a flow diagram shows method 800 that is an exemplary method for performing step 750 in method 700. The method 800 is presented as a series of steps performed by a computer software program described above as the maintenance mode mechanism 350. First, analyze a virtual machine metric (step 810). If the metric analyzed is above a threshold (step 820=yes) then the method is done. If the metric analyzed is not above a threshold (step 820=no) then determine to suspend the VM (step 830). The method is then done.

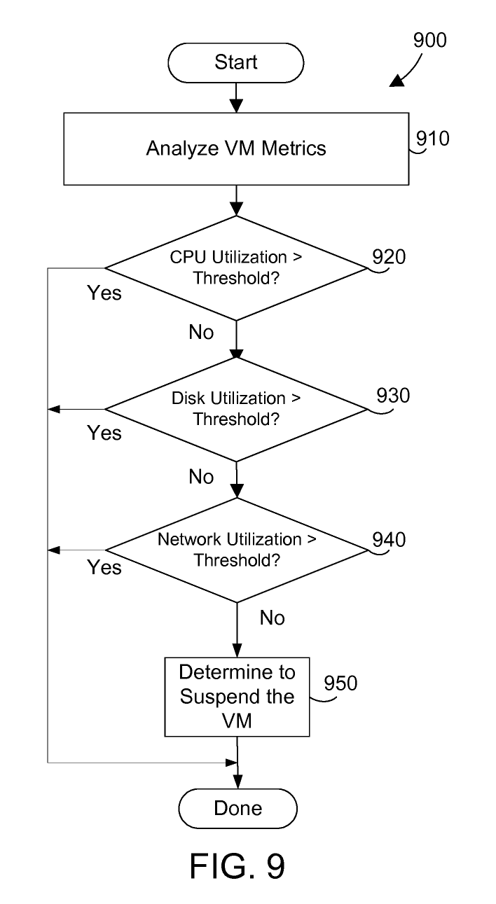

Referring now to FIG. 9, a flow diagram shows method 900 that is another exemplary method for performing step 750 in method 700. The method 900 is presented as a series of steps performed by a computer software program described above as the maintenance mode mechanism 350. First, analyze metrics of a virtual machine, where the metrics include CPU utilization, disk utilization, and network utilization (step 910). Determine if the CPU utilization is above a threshold (step 920). If the CPU utilization is above a threshold (step 920=yes) then the method is done. If the CPU utilization is not above a threshold (step 920=no) then determine if the disk utilization is above a threshold (step 930). If the disk utilization is above a threshold (step 930=yes) then the method is done. If the disk utilization is not above a threshold (step 930=no) then determine if the network utilization is above a threshold (step 940). If the network utilization is above a threshold (step 940=yes) then the method is done. If the network utilization is not above the threshold (all the metrics are below the thresholds) (step 940=no) then determine to suspend the VM (step 950). The method is then done. Note the specific method shown in FIG. 9 represents that if any of the specified thresholds is exceeded then the VM will not be suspended.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The claims and disclosure herein provide an apparatus and method for expediting host maintenance in a cloud computing environment by intelligently suspending essentially inactive virtual machines. Metrics of the VMs associated with the hypervisor are analyzed to determine which VMs can be suspended to reduce the resources necessary to relocate VMs to a new host prior to entering maintenance mode.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A method for placing a host with virtual machines in maintenance mode comprising:
determining at least one virtual machine on a host computer in a cloud computing system is an essentially inactive virtual machine;
suspending the at least one essentially inactive virtual machines to reduce the number of active machines that must be reallocated before entering a maintenance mode; and
entering the maintenance mode.

2. The method of claim 1 where in the step of determining the at least one virtual machine is an essentially inactive virtual machine further comprises the steps of:
analyzing a VM based on a host metric,
comparing the metric to a threshold; and
determining to suspend the VM.

3. The method of claim 2 wherein the metric of the host computer is a metric of the physical properties of the physical machine hosting the host computer.

4. The method of claim 3 wherein the physical properties of the physical machine hosting the host computer include central processing unit (CPU) utilization, disk utilization and network utilization and the determination to suspend the VM is made when any one of these metrics is above a threshold.

5. The method of claim 1 wherein a user it allowed to set the threshold.

6. The method of claim 1 further comprising storing a hold active bit for each virtual machine in the host, where the hold active bit is set to indicate that a corresponding virtual machine should not be suspended.

7. The method of claim 6 wherein the hold active bit for each virtual machine in the host is stored in a table with virtual machine identifiers and corresponding hold active bits.

8. The method of claim 7 further comprising the step of allowing the user to set a hold active bit in the table.

9. The method of claim 1 further comprising the step of providing an option to a user to expedite the maintenance mode by suspending essentially inactive virtual machines.

10. The method of claim 1 further comprising the step of providing an option to a user to verify the selection of essentially inactive virtual machines to suspend.

11. A method for placing a host with virtual machines in maintenance mode comprising:
allowing a user to set a threshold;
providing an option to the user to expedite the maintenance mode by suspending essentially inactive virtual machines
determining at least one virtual machine on a host computer in a cloud computing system is an essentially inactive virtual machine by performing the steps of:
analyzing a VM based on a host metric
comparing the metric to the threshold;
determining to suspend the VM;
wherein the physical properties of the metric include central processing unit (CPU) utilization, disk utilization and network utilization and the determination to suspend the VM is made when all the metrics are below the thresholds;
storing a hold active bit in a table for each virtual machine in the host, where the hold active bit is set to indicate that a corresponding virtual machine should not be suspended;
allowing the user to set a hold active bit in the table; and
suspending the at least one essentially inactive virtual machines prior to entering a maintenance mode when a corresponding hold active bit is not set.
